(19) United States
(12) Patent Application Publication
(10) Pub. No.: US 2008/0133278 A1
(43) Pub. Date: Jun. 5, 2008

(54) Method and system for providing multi-credit card insurance

(76) Inventor: Michael Stanfield, Middlesburg, VA (US)

Correspondence Address: VENABLE LLP, P.O. BOX 34385, WASHINGTON, DC, 20043-9998, US

(21) Appl. No.: 10/108,377

(22) Filed: Mar. 29, 2002

(51) Int. Cl. G06Q 40/00

(52) U.S. Cl. 705/4

(57) ABSTRACT

A method and system for multi-credit card insurance risk measurement is provided. The amount of risk an underwriter undertakes in issuing a credit card insurance policy covering credit cards issued by different issuers can be determined utilizing the invention. Additionally, the invention can be used to determine various parameters of the insurance policy, such as an insurance premium and the insurance policy limits, among others.

### FIELD OF THE INVENTION

The present invention relates to the field of credit card insurance and in particular to providing credit card insurance for multiple credit cards issued by different credit card issuers and a method of risk assessment and premium calculation for credit card insurance.

### BACKGROUND OF THE INVENTION

Modernly, more and more transactions in commerce have come to rely upon the convenience of utilizing a transaction card such as a credit card for the purchasing of goods and services. In fact, credit cards have become ubiquitous in society and it is estimated that U.S. annual credit card charge volume will reach $2 trillion by 2003.

As a value-added provision for their customers and an additional source of revenue, many credit card issuers offer credit insurance. Various forms of credit insurance, such as the following, are available.
Credit Life Insurance—An insurance policy that pays off the outstanding balance of the cardholder's account in the event of natural death. Premiums are based on the balance at the end of the month, or the average balance, of the specific card.
Accidental Death or Disability—An insurance policy that pays off the balance or some portion thereof of the cardholder's account based on a fixed schedule for death and instances of disability. Premiums are based on the balance at the end of the month, or the average balance, of the specific card.
Accidental Death—An insurance policy that pays off the outstanding balance or some portion of a cardholders account in the event of accidental death. Premiums are based on the balance at the end of the month, or the average balance, of the specific card.
Unemployment Insurance—Insurance that pays or waives the minimum payment due for a cardholder's account for a stated period of time when a cardholder has been laid off from their place of employment. Premiums are based on the balance at the end of the month, or the average balance, of the specific card.

In a typical example of the current process, the card issuer/insurer sells an insurance policy to the consumer. The consumer then enjoys the benefits of the insurance protection with respect to the credit card to which the insurance relates. However, the benefit is not widespread to the consumer's other credit cards issued by other issuers/banks. Moreover, under the current process, card issuers/insurers are limited in the amount and number of accounts that can be insured by the policy, as will become evident from the following description of the current process.

In order to cover the risk of providing the insurance, the credit card issuer/Insurer charges an insurance premium to the consumer for providing the insurance protection. The insurance premium is usually a variable amount computed by the card issuer/insurer based on the month end balance of the specific card issued by the specific bank or in some cases the average balance of such card. For example, assume a consumer has four credit cards issued by different issuers. The balances at the end of the month on each credit card are:

| | |
|---|---|
| Card A: | $500 |
| Card B: | $1000 |
| Card C: | $2000 |
| Card D | $3000 |

The consumer purchases a credit card insurance policy with Card B's issuing bank. The consumer is protected by that policy for which he pays, for example, $0.30 per hundred dollars ($3.00) for the credit card insurance. However, such insurance coverage does not extend to other credit cards issued by other entities where the card issuer/insurer has no specific knowledge of the credit card balances.

In each type of insurance described above, or for that matter in any insurance related to the card balance, the credit card company and the insurer, which in most cases are one and the same, are limited in issuing the insurance policy to the underlying specific card. The consumer cannot be offered, or cannot purchase, such insurance with other credit cards they may use, unless they buy the insurance from the other issuing bank. That limitation is created by the lack of information regarding other cards. For example, AmericanExpress issues policies to cover their Optima card balances. However, AmericanExpress does not know what other cards an individual might carry so it cannot offer similar coverage on the consumer's other credit cards. Thus, in all known cases, the insurer measures the balance of a single card, and the insurance coverage relates to that card. Furthermore, the card issuer must also be the insurer as only the card issuer usually has access to information about the credit card.

This leads to a lack of competition in the marketplace and high prices. There is no way to comparison shop for credit insurance under the current system. Either the consumer purchases credit insurance from the entity lending the money or credit or they do not purchase at all. Additionally, the lack of information limits the amount of protection provided and insurance premiums collected by the insurer.

Therefore, there is a need for credit card insurance that can cover multiple credit cards, no matter whom issues the credit card. There is also a need for a method of risk assessment and premium calculation for providing the insurance. Additionally, there is a need method and system which can provide credit card insurance covering multiple credit cards at a reasonable cost.

### BRIEF DESCRIPTION OF THE DRAWINGS

FIG. 1 is a flow diagram of a method according to an embodiment of the invention;

FIG. 2 is a high level schematic diagram of a system according to an embodiment of the invention;

FIG. 3 is a schematic diagram of a computer memory according to an embodiment of the invention; and

FIG. 4 is a detailed flow diagram of a method according to an embodiment of the invention.

### SUMMARY OF THE INVENTION

The present invention provides a method and system for multi-credit card insurance risk measurement. The amount of risk an underwriter undertakes in issuing a credit card insurance policy covering credit cards issued by different issuers can be determined utilizing the invention. Additionally, the invention can be used to determine various parameters of the insurance policy, such as an insurance premium and the insurance policy limits, among others.

The present invention can acquire and utilize information on balances of credit cards issue by multiple parties. The balances of these other cards can be computed, thus allowing a basis for insuring and charging premiums related to multiple credit card balances.

In an exemplary embodiment, a method of risk measurement for multiple credit card insurance is provided. Balance information regarding each of the credit cards is obtained. At least two of the credit cards are provided by different issuers. The insurance policy parameters are then determined based on the policy information.

In a more detailed embodiment, balance information for each credit card is obtained from at least two different databases. The balance information for each credit card is averaged to determine an average balance for that credit card. The average balance for each credit card is used to compute the insurance premium.

Additionally, the method may determine when a customer has added or deleted credit cards. These changes can be dynamically reflected in the insurance parameters determined.

According to another embodiment, a system for multi-credit card insurance risk assessment is provided. The system is typically used in an environment where customers own a plurality of credit cards issued by different card issuers. The system includes means for obtaining account information regarding each of the credit cards and means for determining insurance policy parameters based on the account information.

### DETAILED DESCRIPTION OF THE INVENTION

The present invention provides a method and system for multi-credit card insurance risk measurement. The amount of risk an underwriter undertakes in issuing a credit card insurance policy covering credit cards issued by different issuers can be determined utilizing the invention. Additionally, the invention can be used to determine various parameters of the insurance policy, such as an insurance premium and the insurance policy limits, among others.

As described above, current credit card insurance only covers credit cards issued by a single card issuer. Until the present invention, it has not been possible to obtain a credit card insurance policy that covers credit cards issued by different issuers. The present invention creates the ability for the credit card issuer/insurer to substantially expand the amount of coverage that can be provided. Moreover, the present invention can provide a mechanism for the credit card issuer/insurer to measure the amount of exposure under the policy, to measure and limit that exposure if that is an underwriting requirement and to measure the amount of premium to be charged on a monthly basis.

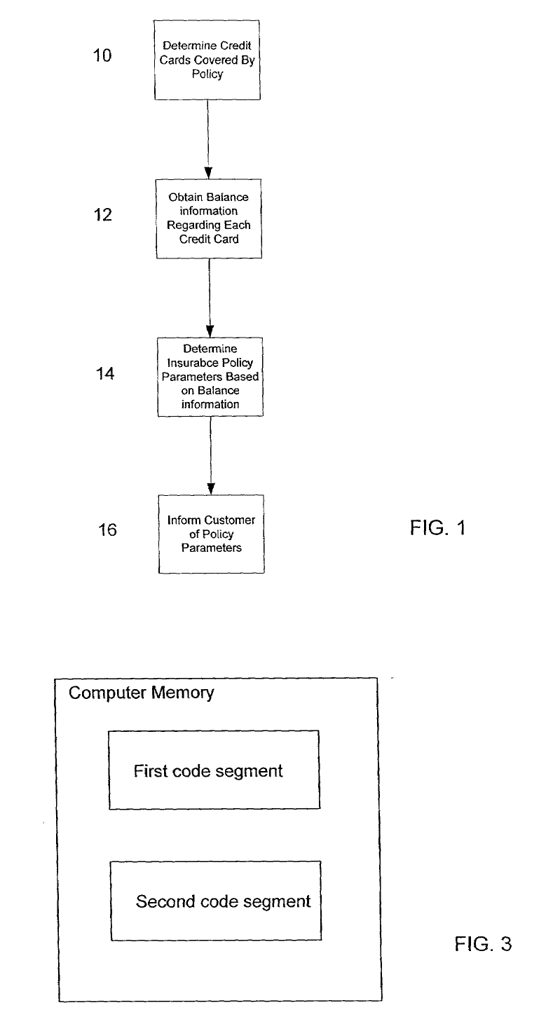

Referring now to FIG. 1, an overview of a method according to an embodiment of the invention will be described. As in initial step, an insurer issues an insurance policy covering a number of credit cards. The policy can cover credit cards issued by different parties. Under the current process of providing credit card insurance, the credit card issuer is typically the insurer. This is due to the fact that in the past only the credit card issuer has access to the account information that is used to determine the parameters, such as the premium, of the insurance policy. However, in the present invention any entity can be the insurer.

In step 10, it is identified which of the consumer's credit cards are covered by the insurance policy. This information can be obtained in any manner for example, from the customer, from a credit bureau or from another source. Next in step 12, data regarding the credit cards is obtained. The more data that can be obtained, the more the insurance policy can be tailored and modified to fit the particular circumstances. Preferably, the data obtained in step 12 includes account or credit information, such as the outstanding balance for the month or average monthly balance, the amount of available credit, etc., for each of the credit cards covered by the policy. A credit report for the customer can be mined to obtain this data. In step 14, various parameters of the insurance policy are determined based at least in part on the data obtained in step 12. For example, the insurance premium for the policy can be calculated based on the outstanding balances for all credit cards covered by the policy. Information regarding each of the credit cards is preferably obtained in step 12. Therefore, this calculation can be carried out no matter who the issuer of the card may be. The customer is then informed of the policy parameters, for example by being billed in the applicable amount for the insurance premium, in step 16.

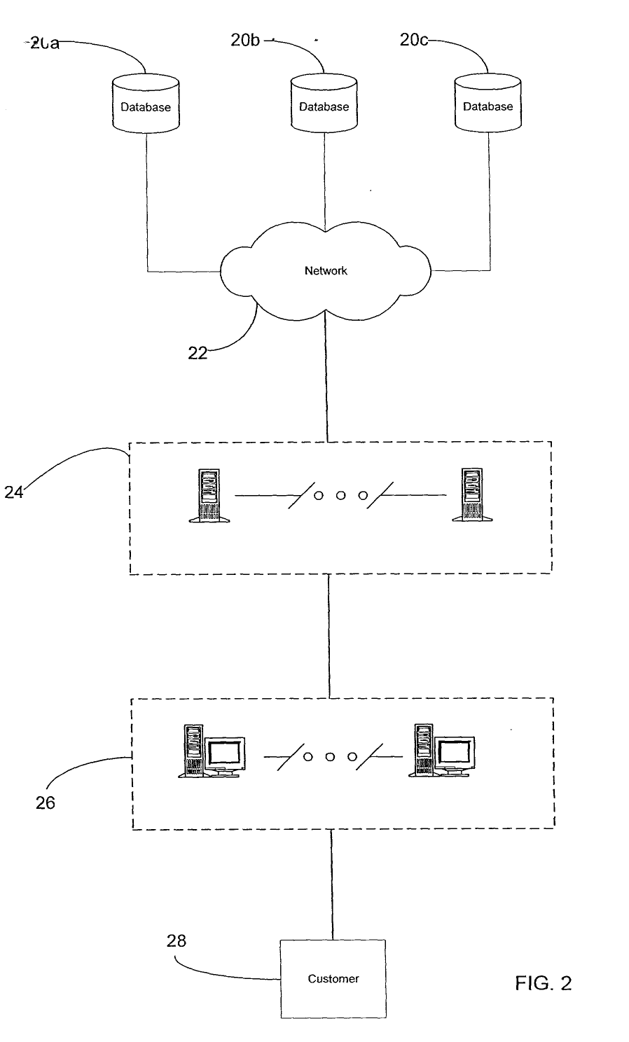

Referring now to FIG. 2, a system that can be used to perform a process according to the present invention is described. At least one computer or server 24 is communicatively connected to at least one database 20a-20c via a network 22. The network 22 may include the Internet, intranets, extranets, Virtual Private Networks (VPNs), and the like. The databases 20a-20c may be any database that contains data of customers needed to carry out the process. As mentioned above, this data can include outstanding balance, available credit, etc. for credit cards. FIG. 2 shows three databases 20a-20c which represent information available from the three current national credit bureaus, Equifax, Experian, and TransUnion.

In an alternative embodiment, the database may represent an account consolidator, such as Yodlee. The customer may have authorized the account consolidator to access and consolidate online the statements of several credit card accounts. The account consolidator accesses the online systems of these credit card companies on a daily basis, obtains the balance information, and forms the balance information into a consolidated statement. The information in the consolidated statement is made available to the computer 22 via the database 20. In a further embodiment, the database 20 may be a database of the credit card companies and credit information can be obtained directly therefrom. Of course, any number of databases can be used.

The computer 24 should include means to obtain the data from the database. This may be accomplished by the database sending the data to the computer or the computer may need to search or mine the information available in the database to find the relevant data. In this regard, the computer may include the necessary software to perform these functions. For example, as shown in FIG. 3, the computer may include in a memory portion a first code segment for a communication module that interfaces with the databases and acquires the data. A communication module should also be provided to interface with the credit card company or insurer.

To facilitate the acquisition of data relating to the credit cards, the computer 24 should have access to some basic customer information. The customer information may simply be a customer name or social security number or it may associate the name or number with the credit cards the customer owns. The customer information may also include information about the insurance policy. This information may be stored on a separate database accessible by the computer or in the computer memory. Using the customer information, the computer 24 communicates with the databases 20 to obtain the data. In an exemplary embodiment, the computer determines which of the credit cards covered by the insurance policy have balances, what those balances are, and any other information needed to measure the risk or determine the parameters of the insurance policy.

After retrieving the data from the databases, the computer uses that information to determine parameters of the insurance policy. This can be done with a second code segment for determining the insurance policy parameters shown in FIG. 3. Alternatively, the computer can pass the information along to the insurer or another entity that can determine the parameters. After the parameters are determined, they can be provided to the customer and/or the insurer. FIG. 2 illustrates the parameters being provided to a credit card company 26 that has issued credit card insurance to its customers. The computer 24 can calculate insurance premiums and provide the amount of the premium to the credit card company 26 or other insurer. The credit card company 26 then charges the customer 28 the premium, for example, by charging the customer's credit card issued by the insurer.

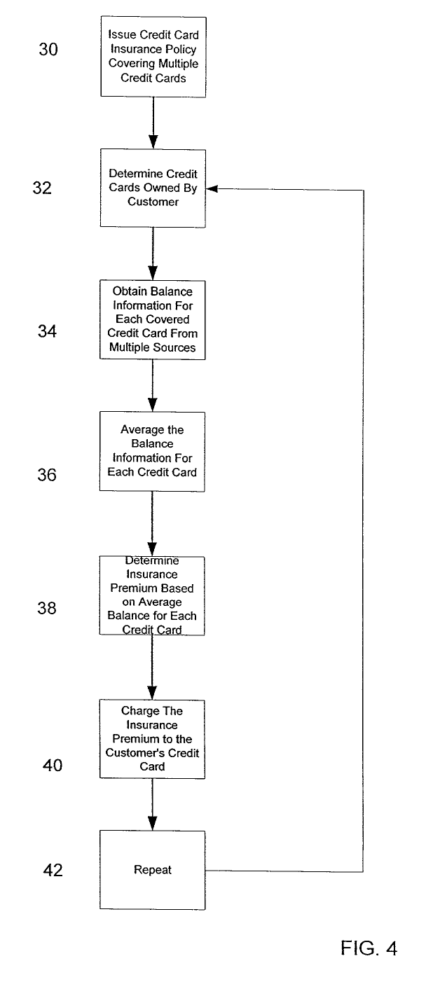

FIG. 4 illustrates a more detailed process according to a further embodiment of the invention. The system shown in FIG. 2 may be used to carry out this method. As discussed above, credit has become widely available and most consumers today use several different credit cards. These credit cards may or may not be provided by the same card issuer. Assume for this example, a customer uses four credit cards, each credit cards being issued by a different card issuer. The customer purchases a credit card insurance policy, for example, a credit life policy described above, with Card C's issuing bank. Card C's issuing bank sells the consumer a multi-card Credit Life Insurance program that, in this case, insures all credit cards owned by the customer per step 30. In an alternate embodiment, only selected ones of the customer's credit cards, such as those chosen by the customer, may be covered by the credit card insurance policy.

The present invention allows parameters of the insurance policy to be determined dynamically based on information about the credit cards. Exactly what parameters can be determined will depend in part on the information that is available about the credit card. Usually balance information about credit cards is available from various databases, such as a national credit bureau or the credit card issuer. Credit report monitoring techniques may be used to obtain data regarding the credit cards covered by the insurance policy.

The customer may add new credit cards or delete credit cards depending on the situation. Since the credit card insurance policy issued to the customer in this example covers all the credit cards owned by the customer, it is determined in step 32 exactly what credit cards are owned by the customer at that particular time. As credit cards are added or deleted by the consumer, those changes in credit card status are usually posted in the credit bureau data. That information can be retrieved and used in determining the insurance premium. Thus, the consumer receives the benefit of insurance of new cards and the elimination of the costs of insuring cards that are closed or have no balances.

In step 34, balance information or other data is retrieved for each credit card. The information is preferably retrieved from at least two different databases. The balance information from each database for each credit card is averaged and the average is used in subsequent calculations, for example, calculating the insurance premium. Use of this averaging technique will mitigate errors and timing issues as information is reported and entered into the databases. Here, the information is received from three databases that represent the three current national credit bureaus. The following table illustrates balance information that may be received from the databases.

| | Database 1 | Database 2 | Database 3 | Average |
|---|---|---|---|---|
| Card A | $500 | $490 | $510 | $500 |
| Card B | $1000 | $1100 | $900 | $1000 |
| Card C | $1800 | $2200 | $2000 | $2000 |
| Card D | $3200 | $3000 | $2800 | $3000 |

Total $6500

Consequently, at a predetermined time, information on the outstanding balances the customer has at Card A, B, C and D is obtained from three different databases. The outstanding balances for each credit card from each database is then averaged per step 36. The average balances are totaled and used to determine the insurance premium in step 38. In this case, the total average balance is $6,500, as can be seen from the above table. Most credit card insurance calculates the premium as a percentage of the total outstanding balance, for example $0.30 per hundred dollars of outstanding balance. Here, the gross premium will be $6.500*3 or $19.50 per month. Of course, the insurance premium may be determined based on other information, such as an average monthly balance, and other methods may be used to calculate the premium.

Moreover, various other parameters for the insurance policy can be determined or adjusted based on the data obtained about the credit cards. For example, the policy limits can be adjusted based on the information gathered. Most credit card insurance policies insure the customer up to the credit limit for the card. The insurer may not cover any amounts exceeding the credit limit or may charge an additional premium for such coverage. Thus, the method can also be used for risk assessment purposes.

After the insurance premiums or other parameters are determined, they should be communicated to the insurer and/or customer. This can be done in any manner. In this example, the customer may be issued a statement detailing the balances on the various cards covered by the insurance policy. In a preferred embodiment, one of the card issuers is also the insurer. The card issuer/insurer may then charge the premium amount to the customer on their credit card as shown in step 40.

As described above, the insurance premium is typically calculated based on the credit card balance. As is known, most credit cards bill on a monthly cycle. Thus, the balance and potential risk to the insurer changes monthly. Accordingly, balance information for each of the credit cards covered by the policy should be retrieved from the databases and the calculations performed on a monthly basis. Therefore, the process returns to step 32 and repeats.

Accordingly, a system and method for providing multi-credit card insurance is provided. The present invention allows an insurer to measure the risk and calculate parameters of the insurance policy even if the insurance policy covers credit cards issued by different issuers. Moreover, the present invention can compute that there are balances at multiple cards, what those balances are, and then charge premiums reliably based on that balance information. According to one embodiment, a computer at a central location can calculate the parameters. In another embodiment, the information is passed along to the insurer, who calculates the parameters.

The present invention allows for more insurance options for the consumer, instead of having to rely only on the credit card issuer for insurance for that particular card. Furthermore, the method and system increases the premium per acquisition dollar thereby creating an avenue for lower pricing to the consumer.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described. For example, various information other than balance information can be gathered. The gathered information can be used to determine other parameters. Additionally, the different computers and processes they perform can be combined.

I claim:

1. A method of risk measurement for multiple credit card insurance, comprising:
obtaining balance information regarding each of the credit cards, at least two of the credit cards being provided by different issuers; and
determining insurance policy parameters based on the policy information.

2. The method of claim 1, wherein balance information is obtained monthly

3. The method of claim 1, wherein the insurance policy covers selected ones of the credit cards.

4. The method of claim 1, wherein the policy covers all credit cards owned by the customer.

5. The method of claim 4, further comprising determining all the credit cards owned by the customer using credit report monitoring techniques.

6. The method of claim 1, further comprising:
determining when the customer has added another credit card; and
automatically including balance information regarding the added credit card in determining the insurance policy premium.

7. The method of claim 1, further comprising:
determining when the customer has deleted a credit card; and
automatically deleting balance information regarding the deleted credit card in determining the insurance policy premium.

8. A method for insuring multiple credit cards issued by different card issuers, comprising:
receiving balance information regarding each credit card from at least one database; and
computing an insurance premium based on the balance information.

9. The method of claim 8, further comprising charging a customer the insurance premium for providing selected insurance protection.

10. The method of claim 8, wherein the database is a national credit bureau.

11. The method of claim 8, further comprising:
receiving the balance information for each credit card from at least two different databases;
averaging the balance information received for each credit card to determine an average balance for that credit card; and
using the average balance as the balance information to compute the insurance premium.

12. The method of claim 8, wherein the balance information for all the credit cards is received from the same database.

13. The method of claim 12, wherein the database is an account consolidator.

14. The method of claim 8, wherein the balance information for the credit cards issued by different card issuers is received from different databases.

15. The method of claim 8, further comprising:
determining when the customer has added another credit card; and
automatically receiving balance information regarding the added credit card.

16. The method of claim 8, further comprising:
determining when the customer has deleted a credit card; and
automatically deleting balance information regarding the deleted credit card from the computation.

17. The method of claim 8, wherein the charging step comprises directly charging the insurance premium to a selected one of the customer's credit cards.

18. The method of claim 17, wherein the selected one of the credit cards is the credit card issued by an insurer.

19. The method of claim 8, wherein the balance information includes the card balance for each credit card covered by the policy at the end of a billing cycle.

20. The method of claim 8, wherein the balance information includes an average monthly balance for each credit card covered by the policy.

21. A method for insuring a plurality of credit cards owned by a customer and issued by multiple parties, comprising:
determining all credit cards owned by the customer;
at a predetermined time each month, determining on outstanding balance an each credit card owned by the customer;
totaling all of the outstanding balances; and
calculating a premium based on the total of the balances.

22. The method of claim 21, further comprising charging the premium to the customer.

23. The method of claim 21, wherein the determining step comprises monitoring a credit report for the customer.

24. A method for providing credit card insurance, comprising:
issuing a credit card insurance policy to a customer having a plurality of credit cards, at least two of the credit cards being issued by different card issuers;
generating an insurance premium based on account information regarding at least two of the credit cards that are issued by different card issuers; and
charging the insurance premium to the customer.

25. The method of claim 24, wherein the insurance premium is based on a type of insurance provided.

26. The method of claim 24, wherein the account information includes the average balance for the month.

27. The method of claim 24, wherein the account information includes balance information for each of the plurality of credit cards.

28. The method of claim 24, wherein the account information includes the balance on each credit at the end of a billing cycle.

29. The method of claim 24, further comprising:
gathering balance information for at least one card from multiple sources; and
averaging the balance information.

30. In an environment where customers own a plurality of credit cards issued by different card issuers, a system for multi-credit card insurance risk assessment, comprising:
means for obtaining account information regarding each of the credit cards; and
means for determining insurance policy parameters based on the account information.

31. The system of claim 30, wherein the means for obtaining comprises a first computer code segment executing on a computer processing unit.

32. The system of claim 30, wherein the means for determining comprises a second computer code segment executing on a computer processing unit.
